(19) United States
(12) Patent Application Publication
(10) Pub. No.: US 2021/0023742 A1
(43) Pub. Date: Jan. 28, 2021

(54) METHOD FOR MANUFACTURING RECYCLABLE ENVIRONMENT-FRIENDLY ORGANIC PAPER

(71) Applicants: Chun Ming Huang, Taipei City (TW); HO ASIA HUANG INTERNATIONAL CO., LTD., Taipei City (TW)

(72) Inventor: Chun Ming Huang, Taipei City (TW)

(21) Appl. No.: 16/521,590

(22) Filed: Jul. 25, 2019

(51) Int. Cl. B29C 43/00; C08J 5/18; C08J 7/04; C08K 3/40; C08K 3/36; B29C 43/24

(52) U.S. Cl. CPC B29C 43/003; C08J 5/18; C08J 7/04; C08K 3/40; B29K 2067/046; B29C 43/24; C08J 2403/02; C08J 2497/02; C08J 2405/08; C08K 3/36

(57) ABSTRACT

A method is provided for manufacturing recyclable environment-friendly organic paper, in which a biomass plastic material, which is one of a biodegradable plastic (such as PLA), a biobased plastic (such as NPP), and a mixture of the two is used as a primary raw material, and the biomass plastic material and an inorganic mineral material (such as inorganic glass powder, mineral powder, and sand) and a bioplastic assisting agent (such as starch, apple pulp, egg shell, and the likes) are directly deposited into a compression and extension paper making machine to make environment-friendly organic paper. The environment-friendly organic paper so made does not contain fossil organic material (such as polypropylene), and thus no high temperature, smoke, and toxicant gases will be generated during burning and combustion and residuals of burning and combustion are primarily the natural inorganic minerals fraction can return to the earth and the nature.

### (a) TECHNICAL FIELD OF THE INVENTION

The present invention generally relates to a method for manufacturing recyclable environment-friendly organic paper, and more particularly to one that uses a biomass plastic that is one of a biodegradable plastic (such as polylactic acid (PLA)), a biobased plastic (such as natural polymer plastic (NPP)), or a mixture thereof, as a primary constituent material, so that burning and combustion do not generate high temperature, smoke, and toxicant gases, exhibiting such environment-friendly characteristics that residuals of burning and combustion that are primarily the natural inorganic minerals fraction can return to the earth and the nature.

### (b) DESCRIPTION OF THE PRIOR ART

Patent document GP248335, which was filed on Aug. 8, 2011 by the present applicant, discloses a method for manufacturing recyclable mineral paper, which uses generally mineral materials and polypropylene (PP) as primary ingredients to make synthetic paper, such as 60-85 wt % natural inorganic mineral powder, 15-40 wt % polypropylene (PP), and 1-5 wt % assisting agents, through a continuous compression molding process to form paper sheets.

However, the synthetic paper as proposed in the above patent document uses PP as one primary ingredient and will not be oxidized and decomposed through interaction with the power of the nature and the environment in a short period of time once disposed outdoors, and thus does not help reduce secondary pollution. Further, PP is a substance that is made through refining of fossil material and consequently, the synthetic paper proposed in the above patent document still causes harmful factors, such as high temperature, smoke, and toxicant gasses, when it is put into combustion.

### SUMMARY OF THE INVENTION

An objective of the present invention is to provide a method for manufacturing recyclable environment-friendly organic paper, which comprises: (1) providing an inorganic mineral material, wherein the inorganic mineral material is one of inorganic glass powder, mineral powder (such as calcium carbonate, calcium sulfate, dolomite powder, and the likes), sand (such as sand from deserts), and a mixture of inorganic glass powder, mineral powder, and sand, wherein the inorganic mineral material takes 58-85 wt %; (2) providing a biomass plastic material, wherein the biomass plastic material is one of a biodegradable plastic, such as polylactic acid (PLA), a biobased plastic, such as natural polymer plastic (NPP), and a mixture of a biodegradable plastic and a biobased plastic, wherein the biomass plastic material takes 15-40 wt %; (3) providing a bioplastic assisting agent, wherein the bioplastic assisting agent comprises various starches (such as soybean flour, corn flour, cassava flour, and the likes) or recyclable agricultural resources (such as one or more of apple pulp, sugarcane pulp, coffee dross, wheat straw, rice straw, peanut shells, egg shells, oyster shell, chitin, and the likes, wherein the bioplastic assisting agent takes 1-5 wt %; and (4) directly depositing the inorganic mineral material, the biomass plastic material, and the bioplastic assisting agent into a compression and extension paper making device to have the compression and extension paper making device carry out a continuous compression and extension operation to make environment-friendly organic paper.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart illustrating a method for manufacturing recyclable environment-friendly organic paper according to the present invention.

FIG. 2 is a schematic view showing a compression and extension paper making device according to the present invention.

FIG. 3 is a schematic view showing an automatic metering machine according to the present invention.

FIG. 4 is a schematic view showing an automatic stirring and mixing machine according to the present invention.

FIG. 5 is a schematic view showing a combined sheet forming machine according to the present invention.

FIG. 6 is a schematic view showing a high-density squeezing machine according to the present invention.

FIG. 7 is a schematic view showing a six-roller compression and extension machine according to the present invention.

FIG. 8 is a schematic view showing a cooling and shaping machine according to the present invention.

FIG. 9 is a schematic view showing an automatic roll-winding machine according to the present invention.

FIG. 10 is a schematic view showing a trimming machine according to the present invention.

FIG. 11 is a schematic view showing a dual-side coating machine according to the present invention.

FIG. 12 is a schematic view showing an automatic leveling machine according to the present invention.

FIG. 13 is a schematic view showing a front surface coating machine according to the present invention.

FIG. 14 is a schematic view showing a dry type baking oven according to the present invention.

FIG. 15 is a schematic view showing a back surface coating machine according to the present invention.

FIG. 16 is a schematic view showing a paper rolling machine according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

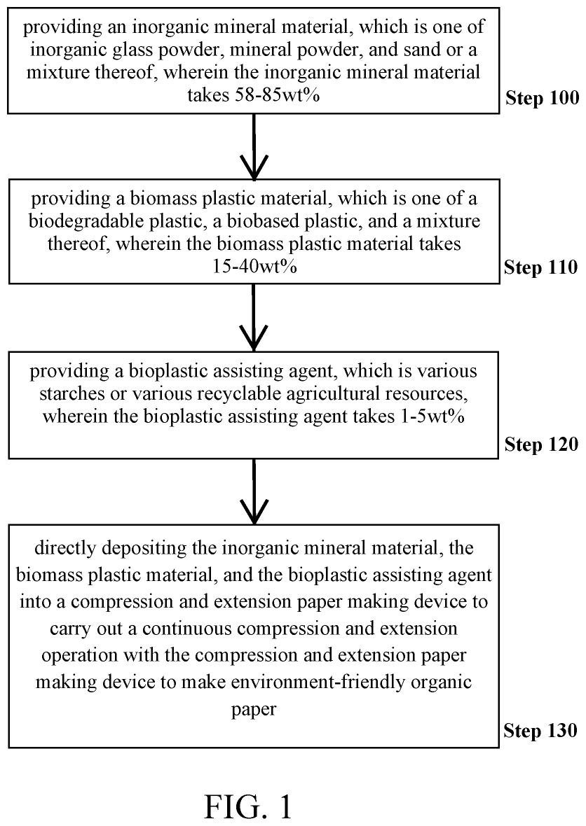

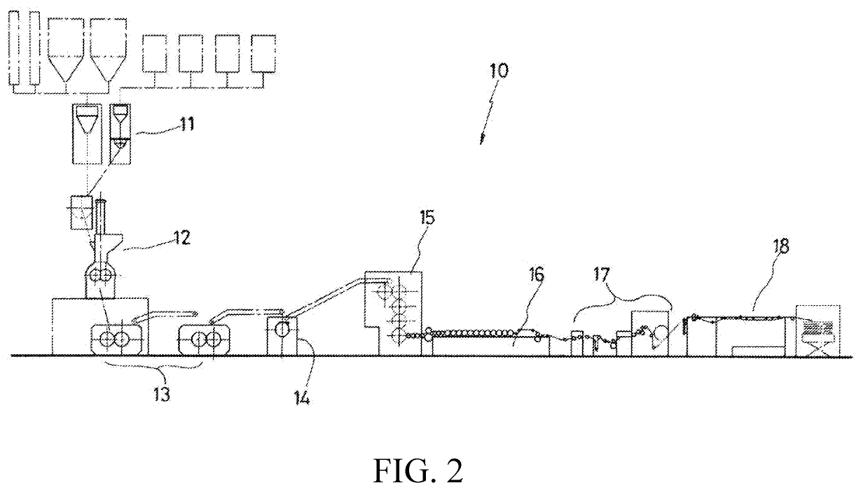

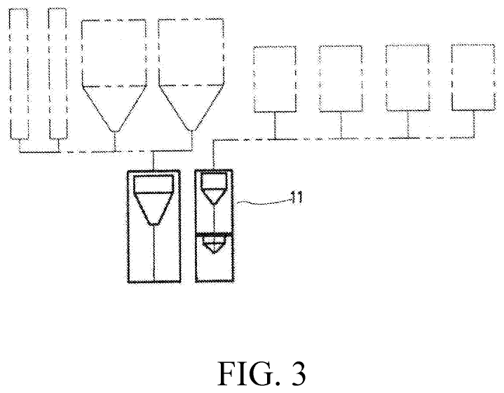

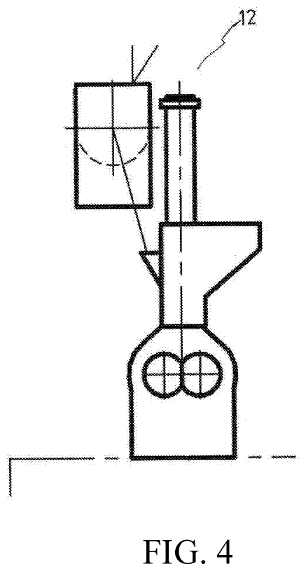

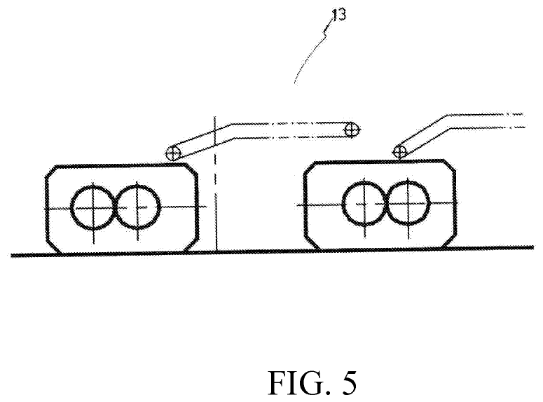

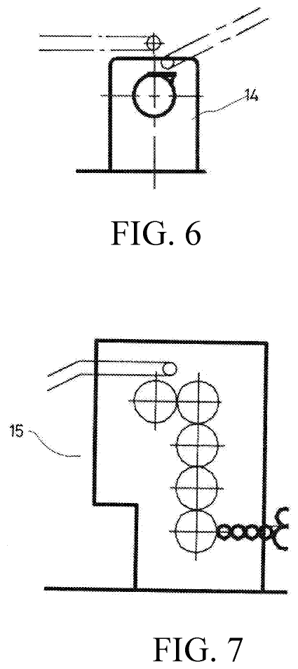

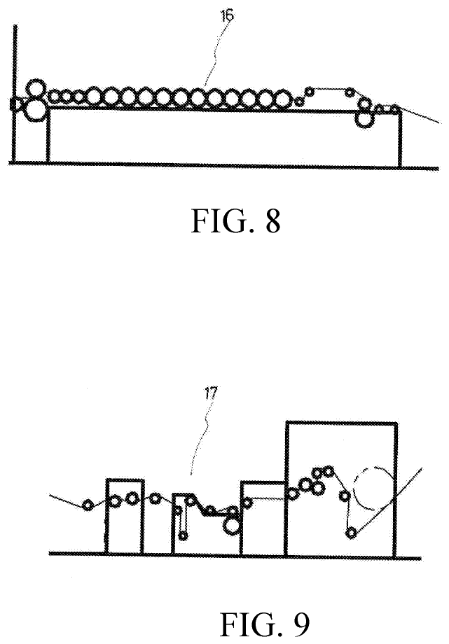

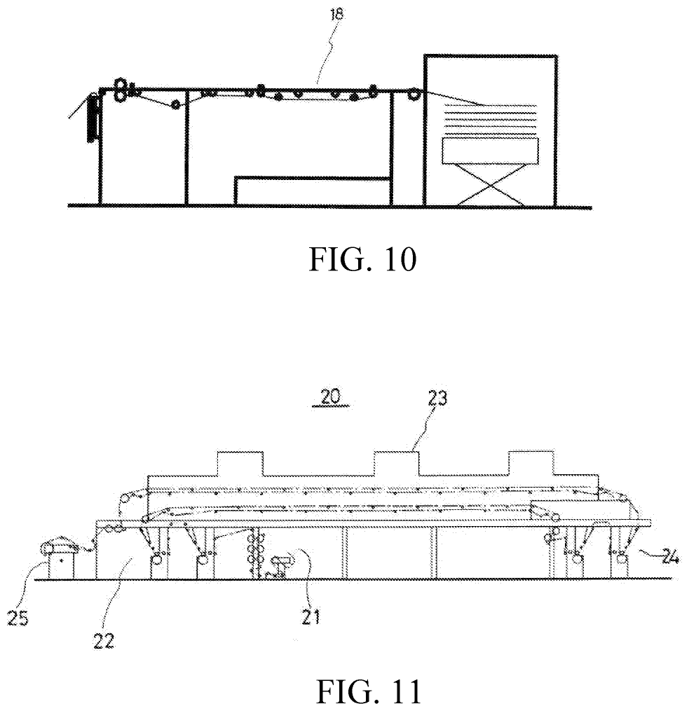

Referring to FIGS. 1-10, the present invention provides a method for manufacturing recyclable environment-friendly organic paper, which comprises:

Step 100, providing an inorganic mineral material, wherein the inorganic mineral material is one of inorganic glass powder, mineral powder (such as calcium carbonate (including light calcium carbonate, heavy calcium carbonate, and colloid calcium carbonate), pulverized coal powder, calcium sulfate, barium sulfate, kaolin, mica powder, zinc oxide, dolomite powder, calcium silicate, glass fiber, hollow glass particulates, silica powder, chalk powder, talcum powder, pigment, titanium dioxide, silicon dioxide, bentonite, clay, diatomite, and mixtures thereof (which is subjected to calcination or not)), sand (such as sand from deserts), and a mixture of inorganic glass powder, mineral powder, and sand, wherein the inorganic mineral material takes 58-85 wt %.

Step 110, providing a biomass plastic material, wherein the biomass plastic material is one of a biodegradable plastic, such as polylactic acid (PLA), a biobased plastic, such as natural polymer plastic (NPP), and a mixture of a biodegradable plastic and a biobased plastic, wherein the biomass plastic material takes 15-40 wt %.

Step 120, providing a bioplastic assisting agent, wherein the bioplastic assisting agent comprises starches (such as soybean flour, corn flour, cassava flour, and the likes) or recyclable agricultural resources (such as one or more of apple pulp, sugarcane pulp, coffee dross, wheat straw, rice straw, peanut shells, egg shells, oyster shell, and chitin, wherein the bioplastic assisting agent takes 1-5 wt %.

Step 130, directly depositing the inorganic mineral material, the biomass plastic material, and the bioplastic assisting agent into a compression and extension paper making device 10 to carry out a continuous compression and extension operation to make environment-friendly organic paper.

The biomass plastic material can be a biobased material, such as NPP. The use of a biobased plastic allows for sustainable recycling and re-molding for uses, and provides a significant advantage that the production of the biobased plastic consumes the least energy as compared to the known kinds of plastics. For example, producing one kilogram of traditional plastic, such as polyethylene terephthalate (PET), has carbon dioxide emission of 4.3 kilograms, while producing one kilogram of biobased plastic (such as NPP) has carbon dioxide emission of only 1.6 kilograms. Considering the current trend of carbon reduction and energy reduction, the production of biobased plastics bring much less environmental contamination than the traditional plastics, and provides products that make recycling and reuse more feasible.

The above-mentioned material, including the inorganic mineral material, the biomass plastic material, and the bioplastic assisting agent, does not need to be processed for formation of raw material mother particles and, instead, it can be directly deposited into a compression and extension paper making device 10 to carry out a continuous compression and extension operation for making environment-friendly paper. In such a continuous compression and extension operation, cut and trimmed residuals or scraps may also be directly fed back to the machine for compression and extension, so that no waste may be generated.

The compression and extension paper making device 10 comprises an automatic metering machine 11, an automatic stirring and mixing machine 12, a combined sheet forming machine 13, a high-density squeezing machine 14, a six-roller compression and extension machine 15, and a cooling and shaping machine 16. In Step 130, the continuous compression and extension operation (for fabrication) comprises the following steps:

Step one: the inorganic mineral material, the biomass plastic material, and the bioplastic agent are introduced into the automatic metering machine 11 and the automatic metering machine 11 performs automatic feeding and metering of the inorganic mineral material, the biomass plastic material, and the bioplastic agent according to predetermined ratios of these constituents to be then supplied to the automatic stirring and mixing machine 12; Step two: the automatic stirring and mixing machine 12 performs continuous mixture and stirring of the inorganic mineral material, the biomass plastic material, and the bioplastic agent to make a paper composition;

Step three: the well mixed paper composition is then fed to the combined sheet forming machine 13 to be subjected to combined pressing so as to cause bi-directional extension of the paper composition and uniform rubbing and kneading to form a continuous paper sheet out of the paper composition in a bonded condition;

Step four: the uniformly rubbed and kneaded continuous paper sheet is passed through the high density squeezing machine 14 for further mixing and pressing of the paper sheet, so as to provide proper hardness and proper tension;

Step five: the six-roller compression and extension machine 15 is used for reversely turning and shaping the continuous paper sheet and to realize bi-directional extension of the continuous paper sheet in lateral and longitudinal directions;

Step six: the cooling and shaping machine 16 is used to perform continuous compression and extension on the continuous paper sheet to induce further bi-directional extension of the sheet in both lateral and longitudinal direction and to control thickness of the sheet, and thus completing the operation.

In Step 5 and 6, the extension of the continuous paper sheet is carried out so as to achieve a ratio between longitudinal tensile strength and lateral tensile strength of the continuous paper is 1:1 to 1:2, or 2:1 to 1:1, or 1:2 to 1:3 and a ratio between longitudinal tear strength and lateral tear strength of the continuous paper sheet is 1:1 to 1:2, or 2:1 to 1:1, or 1:2 to 1:3.

In Step five, the six-roller compression and extension machine 15 is operated by employing high temperature compression and extension and the temperature employed can be adjusted according to the compositional ratio of the continuous paper sheet so as to effectively realize melting, mixture, and bi-directional extension of the continuous paper sheet.

In Step six, the cooling and shaping machine 16 is operable for adjustment of compression and extension time according to a desired paper sheet thickness and product properties.

In an illustrative embodiment of the present invention, an inorganic mineral material of 66 wt %, a biomass plastic material (such as a biobased plastic) of 32 wt %, and a bioplastic assisting agent of 29 wt % are provide to jointly form, in total, 100 wt % of the compositional constituents, which are subjected to mixture, squeezing, and compounding, and then deposited into the compression and extension paper making device 10 for fabrication of recyclable paper sheets of a thickness of 0.1 mm according to the desired product thickness requirement. Alternatively, an inorganic glass powder of 72 wt %, a biomass plastic material (such as a biodegradable plastic) of 24 wt %, and a bioplastic assisting agent of 4 wt % are provided to form, in total, 100 wt % of the compositional constituents, which are subjected to mixture, squeezing, and compounding, and then deposited into the compression and extension paper making device 10 for fabrication of recyclable paper sheets of a thickness of 0.1 mm according to the desired product thickness requirement

Further, according to paper thickness and property, the environment-friendly organic paper made according to the present invention can be used, after further and proper processing, to make monthly calendar, almanac, hanging scroll, map, notebook, instruction leaflet, business log, letter paper, book, commercial marks, poster, label, various hand-carrying bags, wrapping paper, art and craft material, wall paper, surface cover for woven bag, release paper, heat-sealing package bag, backing adhesive label paper, surface bonding material, atlas, self-adhesive mark, surface bonding material for plastic tablet, shopping bag, various hand bags, wall paper, newspaper and loose leaf paper, notebook, book, desk calendar, envelope, shinning paper, instruction leaflet, education material, festival and celebration card, three-dimensional cards, playing cards, business card, name plate, hanging card, painting, book cover, various package boxes, shoe box, cigarette box, tea leaf box, meal pad, window curtain, hanging plate, frozen foodstuff plate for food package, disposable dining utensil, meal box, sun shade for automobile, art lantern decoration, frozen commodity indication plate for convenience stores, three-dimensional paper sculpture, coupon, scoring card, product catalog, cup coaster, plastic floor tile, large-sized advertisement, lantern box advertisement, as well as paper for culture purposes, such as paper for culture purposes, paper for printing, paper for writing, and paper for computer character making, and paper for decoration purposes and paper for packaging purposes. The paper can be used directly and further processing is performed to make a coating on a surface of the paper to form a frosted surface or a shining surface.

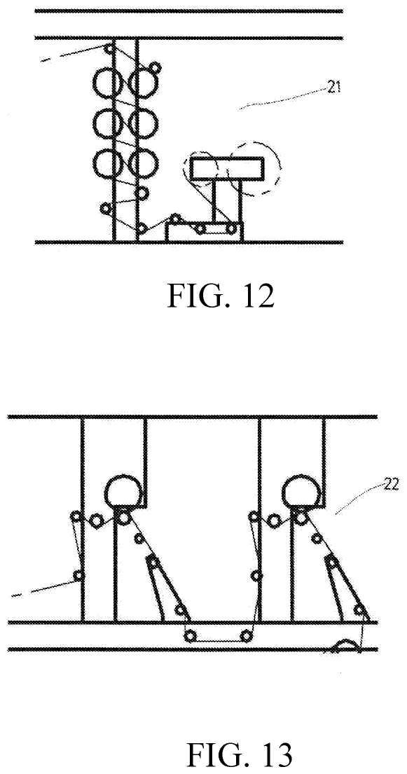

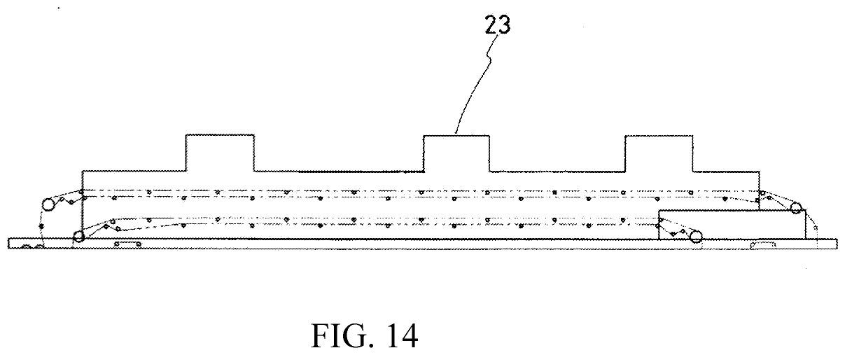

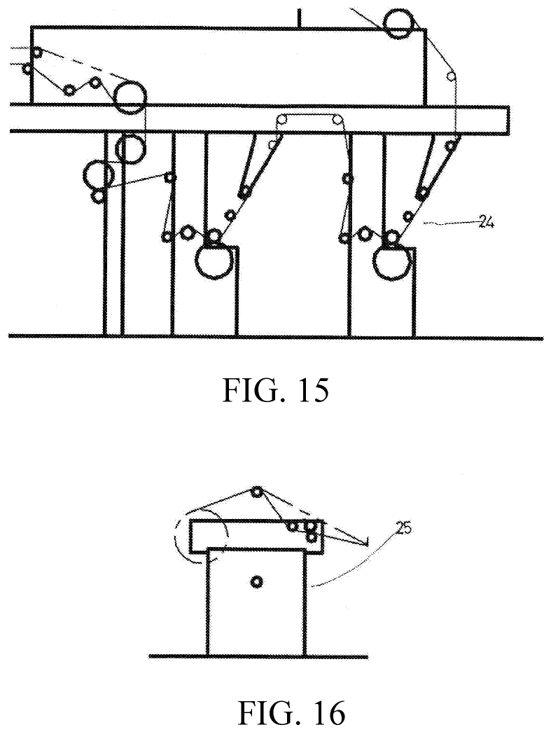

Referring to FIGS. 11-16, the environment-friendly organic paper according to the present invention can be processed to form a coating layer on surfaces thereof, and the coating can be formed of a water-based solution or an oil-based solution. For the case where a water-based solution is used to form the coating, the composition of the water-based coating solution may comprise acrylic resin, isoprophy alcohol, polyvinyl alcohol, clay, anti-static agent, 28% ammonia liquor, pure water, and vinyl acetate. A dual-side coating machine 20 is used to deposit a non-coated environment-friendly organic paper sheet into an automatic leveling machine 21 to have the environment-friendly organic paper sheet dragged and leveled for subsequent performance of corona treatment, whereby the two surfaces of the environment-friendly organic paper sheet, after being treated with high voltage discharging, form a plurality of tiny voids, which help improve bonding force for the coating applied to the surface of the environment-friendly organic paper (the surface treatment being selectively thermal fusion coating, fluent spraying, flame spraying, plasma spraying, and electrostatic spraying). The environment-friendly organic paper sheet is conveyed to a front surface coating machine 22 for first coating, and then the environment-friendly organic paper sheet is conveyed to a dry type baking oven 23 to have the surface of the environment-friendly organic paper sheet dried for subsequent coating on the opposite surface. A back surface coating machine 24 uses a plurality of spraying nozzles to control the amount of coating solution sprayed and realize coating on the opposite surface of the environment-friendly organic paper sheet. The environment-friendly organic paper sheet is conveyed to the dry type baking oven 23 to dry the coated surface, wherein under the condition of being heated, the coated surface of the environment-friendly organic paper sheet can be quickly dried and shows a shining face on the paper surface. Further, for frosting treatment of the coated surface of the environment-friendly organic paper sheet, a frosting roller is employed to carry out such an operation so that the dried smooth coated surface is converted into a frosted surface. Then, a paper rolling machine 25 is used to roll up the coated environment-friendly organic paper sheet into a paper roll.

The technical features of the present invention is that a biomass plastic material, which is one of a biodegradable plastic (such as PLA), a biobased plastic (such as NPP), and a mixture of the two is used as a primary raw material, and the biomass plastic material and an inorganic mineral material (such as inorganic glass powder, mineral powder, and sand) and a bioplastic assisting agent (such as starch, apple pulp, egg shell, and the likes) are directly deposited into a compression and extension paper making machine to make environment-friendly organic paper. The environment-friendly organic paper so made does not contain fossil organic material (such as PP), and thus no high temperature, smoke, and toxicant gases will be generated during burning and combustion. Further, burning and combustion of such paper do not generate high temperature, smoke, and toxicant gases, showing such environment-friendly characteristics that residuals of burning and combustion that are primarily the natural inorganic minerals fraction can return to the earth and the nature. Further, the biobased plastic (such as NPP) that is involved in the fabrication help achieve effects of carbon reduction and energy saving, and thus meeting the current trend of environmental protection.

Further, the environment-friendly organic paper can be decomposed in the nature by microorganisms into carbon dioxide and water, or being alternatively photo-degradable, which can be decomposed by exposure to ultraviolet components contained in the sun light to have main chains of large molecules thereof broken, or being alternatively, oxidation decomposable, which is decomposed through oxidation of the constituent materials thereof with oxygen to form oxides. Thus, used paper can be readily recycled, and burning of such paper only combusts only a relatively minor fraction of biodegradable plastic (such as PLA) or biobased plastic, such as NPP, or a mixture thereof so that burning and combustion of such paper do not generate high temperature, smoke, and toxicant gases and residuals of burning and combustion contains a major fraction of natural inorganic mineral powder or inorganic glass powder, or sand from desert, or a mixture thereof that can return to the earth and the nature, generating no toxicant gas or causing no water pollution, and completely suiting the needs for environmental protection. Further, the composition of the recyclable environment-friendly organic paper according to the present invention can be automatically fed and metered according to the ratios of the constituent components thereof and requiring no formation of particles, which leads to a reduction of cost for mixture of the components and formation of raw material mother particles.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for manufacturing recyclable environment-friendly organic paper, comprising the following steps:
(1) providing an inorganic mineral material, wherein the inorganic mineral material is one of inorganic glass powder, mineral powder, and sand or a mixture thereof, wherein the inorganic mineral material takes 58-85 wt %;
(2) providing a biomass plastic material, wherein the biomass plastic material is one of a biodegradable plastic, a biobased plastic, and a mixture thereof, wherein the biomass plastic material takes 15-40 wt %;
(3) providing a bioplastic assisting agent, wherein the bioplastic assisting agent takes 1-5 wt %; and
(4) directly depositing the inorganic mineral material, the biomass plastic material, and the bioplastic assisting agent into a compression and extension paper making device to carry out a continuous compression and extension operation to make environment-friendly organic paper.

2. The method according to claim 1, wherein the bioplastic assisting agent comprises starch.

3. The method according to claim 1, wherein the bioplastic assisting agent comprises recyclable agricultural resources that include one or more of apple pulp, sugarcane pulp, coffee dross, wheat straw, rice straw, peanut shells, egg shells, oyster shell, and chitin.

4. The method according to claim 1, wherein the compression and extension paper making device comprises an automatic metering machine, an automatic stirring and mixing machine, a combined sheet forming machine, a high-density squeezing machine, a six-roller compression and extension machine, and a cooling and shaping machine.

5. The method according to claim 4, wherein the continuous compression and extension operation carried out with the compression and extension paper making device comprises the following steps:
Step one: introducing the inorganic mineral material, the biomass plastic material, and the bioplastic agent into the automatic metering machine as constituents to allow the automatic metering machine to perform automatic feeding and mixing of the constituents of the composition according to predetermined ratios of the constituents to be then supplied to the automatic stirring and mixing machine;
Step two: the automatic stirring and mixing machine performing continuous mixture and stirring of the inorganic mineral material, the biomass plastic material, and the bioplastic agent to make a paper composition;
Step three: directly feeding the paper composition so stirred and mixed to the combined sheet forming machine to be subjected to combined pressing so as to cause bi-directional extension of the paper composition and uniform rubbing and kneading to form a continuous sheet out of the paper composition in a bonded condition;
Step four: feeding the uniformly rubbed and kneaded continuous paper sheet through the high density squeezing machine for further mixing and pressing the sheet, so as to provide the sheet with proper hardness and proper tension;
Step five: the six-roller compression and extension machine operating for reversely turning and shaping the continuous paper sheet and to realize bi-directional extension of the continuous paper sheet in both lateral and longitudinal directions; and
Step six: the cooling and shaping machine operating to perform continuous compression and extension on the continuous paper sheet to induce further bi-directional extension of the sheet in both lateral and longitudinal direction and to control thickness of the sheet.

6. The method according to claim 5, wherein the six-roller compression and extension machine of Step five is operated by employing high temperature compression and extension and the temperature employed is adjustable according to the characteristics of the compositional ratio of the continuous paper sheet so as to effectively realize melting, mixture, and bi-directional extension of the continuous paper sheet.

7. The method according to claim 5, wherein the cooling and shaping machine of Step six is adjustable for compression time according to a desired paper thickness and a product property.

8. The method according to claim 1, wherein the environment-friendly organic paper is further subjected to surface coating of an oil-based coating solution.

9. The method according to claim 1, wherein the environment-friendly organic paper is further subjected to surface coating of a water-based coating solution.
